(19) United States
(12) Patent Application Publication
(10) Pub. No.: US 2015/0324356 A1
(43) Pub. Date: Nov. 12, 2015

(54) A METHOD AND A SYSTEM FOR CREATING A USER PROFILE FOR RECOMMENDATION PURPOSES

(71) Applicant: TELEFONICA, S.A., Madrid (ES)

(72) Inventors: Juan Jose ANDRES GUTIERREZ, Madrid (ES); Paulo VILLEGAS NUÑEZ, Madrid (ES); Manuel MARTIN MARTINEZ, Madrid (ES)

(73) Assignee: TELEFONICA, S.A., Madrid (ES)

(21) Appl. No.: 14/443,281

(22) PCT Filed: Nov. 8, 2013
(86) PCT No.: PCT/EP2013/073358

§ 371 Date: May 15, 2015

(30) Foreign Application Priority Data
Nov. 16, 2012 (ES) P201231770

(51) Int. Cl. G06F 17/30

(52) U.S. Cl. CPC G06F 17/30029; G06F 17/30867; G06F 17/3053; G06F 17/30038

(57) ABSTRACT

The method comprising a first user having a plurality of computing devices connected to a local network performing the following steps:
searching, a content collection system, for multimedia content items in said plurality of computing devices;
gathering, by said content collection system, said multimedia content items found for a specific domain and generating a list with said gathered multimedia content items;
identifying, a content identification system, each one of said multimedia content items included in said list; and
creating a profile generator system a user profile of said first user by analyzing all of said identified items in said multimedia content and further using said created first user profile for providing multimedia content recommendation to said first user, and possibly to additional users related to said first user through a recommendation engine.

The system of the invention is adapted to implement the method of the invention.

### FIELD OF THE ART

The present invention generally relates to recommendation processes and more particularly to a method and a system for creating a user profile for recommendation purposes.

### PRIOR STATE OF THE ART

One of the most important problems of the recommendation process is reduced to the problem of rating estimation for items that have not been seen by a specific user. This estimation is usually based on events given by this user to other elements (e.g. ratings) and some other information. Once the engine can estimate the ratings of the elements not classified yet, it recommends items to the user with the highest estimated index of preference.

Extrapolations from known to unknown ratings are usually done by specifying heuristics that define the utility function and empirically validating its performance and estimating the utility function that optimizes certain performance criteria, such as the mean square error. Once the unknown ratings are estimated, selecting the highest rating among all those estimated ratings are used for providing real item recommendations to the user.

The market for recommendation systems has become far-reaching, and it is a technology embedded in everyday interaction in a variety of contexts. The dominant solution is nowadays that of collaborative filtering [4], in which the “other information” used for a given user are preferences expressed by other users in the system that are somehow deemed similar to him/her. Other types of engines, such as content-based recommendation, social or knowledge recommenders, or systems based on semantic processing, also exist. All of them, though, suffer from drawbacks; the most pervasive among them are the “cold start” problem (how to face users with no data available) and the lack of precision stemming from insufficient or incorrect determination of the true user preferences.

The use of existing content available in the range of user devices available in a home network (such as smartphones, computers, video players, etc.) instead of the whole available group of users, to generate predictions is useful to solve the “cold start” problem (how to initiate the user profile from scratch) as well as for improving the characterization in such user profile.

This idea holds on the principle of trust: it is more likely that a long-term item (stored in a device) is a content that the user does not want to delete.

Patent US 20080270351 proposes a method of generating an index for using in searching data stores. This patent is related to one component in the proposed invention (the aggregator module) but fulfills a completely different proposal (building an index for content search) and carries out a different procedure (it is done over different enterprise systems with metadata services with a centralized collection point). Instead, the present invention explores a home network, in which assumes there is no normalized metadata service, it locates media files and it does not generate an index for searching, but perform media identification and build a preferences user profile out of the information gathered, for further recommendation.

The present invention herein presents a method and system in which existing content for a given domain that is located in user devices across a home network can help to build a user profile for recommendation purposes, so that it enables predicting the behavior of the user and greatly improves a media recommendation service to which the user subscribes. Cold start is quite a problem for automatic recommendation engines because they do not have initial data to process in order to create a content list that fits the user preferences. Using this method we solve this “cold start” problem obtaining a first content list that presumably the user likes.

The main problems with existing solutions for content recommendation are:
Cold start problem: In a collaborative filtering system, new items lack rating data and cannot be recommended; the same is true when a new user enters the system.
Data sparsity: In a standard collaborative recommender system, the user-rating data is very sparse. Although dimensionality techniques of reduction offer some help, this problem is still a source of inconsistency and noise in the predictions.
Noise and malicious ratings: Users introduce noise when giving their feedback to a recommender system, in the form of careless ratings (in which lack of recall is an important issue) and malicious entries, which will affect the quality of predictions.
Lack of integration: many recommender systems work as a ‘silo’ service, being able to provide recommendations only on the content base of the service provider, and only on information available on items from the service provider.

In the area of local content management, there exist a number of solutions to organize local libraries of items, mostly revolving around protocols for device discovery across local networks (such as UPnP and DLNA). However the interaction of those discovery services with proper content library management and user profiling is missing.

### SUMMARY OF THE INVENTION

The objective of the recommendation method and system is to model the user preferences to suggest or recommend new content the users will find interesting.

To that end, the present invention relates, in a first aspect, to a method for creating a user profile for recommendation purposes, comprising a first user having a plurality of computing devices connected to a local network. The method in a characteristic manner and on contrary of known proposals comprises performing following steps:
searching, a content identification system, for multimedia content items in said plurality of computing devices;
gathering, by said content collection system, said multimedia content items found for an specific domain and generating a list with said gathered multimedia content items;
identifying, a content identification system, each one of said multimedia content items included in said list; and
creating a profile generator system a user profile of said first user by analyzing all of said identified items in said multimedia content and further using said created first user profile for providing multimedia content recommendation to said first user, and possibly to additional users related to the said first user through a recommendation engine.

Preferably, the multimedia content is gathered by means of any of a UPnP, a Bonjour and/or a Samba/CIFs technique, among any other technique.

The content collection system then sends the generated list of previous multimedia content items together with a set of metadata associated to said multimedia content items to said content identification system and further produces, in a preferred embodiment, a fingerprint for each one of said multimedia content items of said list.

The list and description of each one of said identified multimedia content items included in said list are further stored in a local library.

The analysis of all of said identified items includes using a timestamp in said identified items as a time-dependent factor to set and/or modify the preference value for said items. Preferably, said set and/or modified preference value is computed by estimating preference values by means of a recommendation engine i.e. a sandbox recommendation engine, used only for iterative preference estimation, where said recommendation engine uses also said time-dependent factor.

The first user, in another embodiment, can also correct, amend and/or improve said stored identified multimedia content items and their preferences for them.

The method is periodically repeated every certain period of time to improve the profile by adding new files discovered in the local network.

In another embodiment, said multimedia content recommendation is provided to third parties by using a recommendation distributor module, which further feeds the multimedia content recommendation to a local recommender.

The local recommender uses said local library to modify and improve said multimedia content recommendation.

In an embodiment, said improvement can consist on using said local library to inject explanations for items in said multimedia recommendation, personalized for said first user, by linking said items to the items contained in said local library. Said improvement can also consist, in yet another embodiment, on using said local library to include additional items in said multimedia content recommendation, by using the items in said local library together with said time-dependent factor.

The invention in a second aspect relates to a system for creating a user profile for recommendation purposes, comprising a plurality of computing devices owned by a first user connected to a local network.

On contrary to the known proposals, the system of the second aspect comprises:
a content collection system searching for multimedia content items in said plurality of computing devices, gathering said multimedia content items for an specific domain and generating a list with said gathered multimedia content items;
a content identification system identifying each one of said multimedia content items included in said list;
a profile generator system for creating a user profile of said first user by analyzing all of said identified items in said multimedia content; and
a recommendation engine using said created first user profile for providing multimedia content recommendation to at least a second user.

The plurality of computing devices comprises any of a PC, a tablet, a mobile phone, a video player or any other device with computing capacity able of storing multimedia content.

In the system, the content collection system is located within at least one of said plurality of computing devices in the local network and can include a fingerprint generator module to produce a fingerprint for each one of said multimedia content items.

Moreover, the content identification system also comprises a metadata database containing a catalog of elements from said specific domain being targeted and the recommendation distributor module is arranged to the recommendation engine to provide said multimedia content recommendation to third parties and further feeding them to a local recommender.

Finally, the system further comprises a local library management system to provide a plurality of additional services to at least said second user.

The system of the second aspect is adapted to implement the method of the first aspect.

### BRIEF DESCRIPTION OF THE DRAWINGS

The previous and other advantages and features will be more fully understood from the following detailed description of embodiments, with reference to the attached, which must be considered in an illustrative and non-limiting manner, in which:

FIG. 1 is a representation of the overall system diagram of the present invention.

FIG. 2 is a sequence diagram of the operation of the present invention.

FIG. 3 shows an example of a user adjustment of estimated preferences, according to an embodiment of the present invention.

FIG. 4 is a basic example of preference categorization by term showing several degrees of preference.

### DETAILED DESCRIPTION OF SEVERAL EMBODIMENTS

The proposed invention consists of a multiple-device content collection and identification system as well as a recommendation profile builder that uses the set of identified content to generate predictions for a user and feed a recommendation engine (whose exact specification is not part of this invention). The resulting profile is not limited to the gathered content itself, but tries to add information about the user preference about each content item by analyzing other parameters surrounding the file (e.g. name, path); it also provides a streamline interface for users to interact with their local library and provide feedback in an optimized way. This way, the user profile will be more accurate.

The process typically starts when the user subscribes to the media recommendation service (which may or may not include actual media delivery, depending on service options). Upon user's signup and agreement of the terms of service, the local part of the service (content collection module) is started and the final outcome (the media recommendation profile for the user) is then fed to the recommendation engine, which then can provide items better adapted to the user tastes. As additional benefit, the system provides an administration and discovery service through which the user can access and manage the contents in its local home network, and also improve the definition of her profile. The procedure could optionally be re-run at specific intervals, to improve the profile by adding new files discovered in the local home network. Provision is made for multi-user homes, in which every member of the household can have their own differentiated profile being fed selectively from the home content library.

In what follows the present invention will assume, for the sake of clarity that the domain being targeted is that of video content (movies, TV programs, etc.). The system, however, can work equally well in other domains that share a minimum of characteristics with video (i.e. media content that is consumed in a home device), such as music.

The first step of the invention requires obtaining a set of contents from all user devices by means of any of the well-known techniques, such as UPnP, Bonjour, Samba/CIFS, etc.

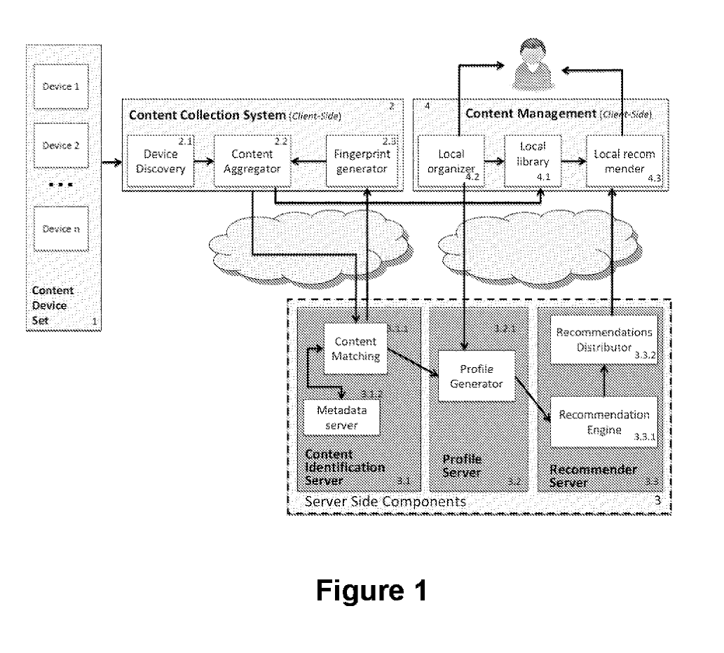

FIG. 1 shows a diagram of the complete system. The first two high-level blocks correspond to components or devices within the user's home network, while the rest are subsystems at the service provider.

The system diagram consists of the following elements:
1. Content device set. It represents all user devices across a home network, for example, iPods, smartphones, video players, computers, tablets, etc., i.e. any device capable of storing multimedia content regardless of its format (avi, mkv, divx, xvid, etc.).
2. Content collection system. This is a module located within one of the devices in the home network. Its optimal place is the gateway between the home network and an Internet connection (e.g. an ADSL router), but depending on convenience it could also be placed in a local PC or a multimedia box (e.g. an OTT player), as long as it has access to the local content delivery network (typically deployed over Wi-Fi or wired Ethernet).
   The content collection system has the mission of finding out the existing content items within user's reach, which presumably have been downloaded and played by the user at some time and are therefore part of her media interests. It contains the following sub-elements:
   2.1. Device Discovery Module. This module is in charge of discovering all devices in the local network using several protocols. The aim of this ID is not to provide a method for discovery; instead it will rely on available standardized protocols such as UPnP, DLNA or Bonjour.
   2.2. Content Aggregator Module. This module obtains a list with all the multimedia content in a wide sense stored in the previously discovered devices. This process includes fetching all necessary metadata in order to unambiguously identify the content. The minimum elements to capture are filename, file timestamp and media duration. When possible, additional metadata will also be inferred regarding the user preferences about each element (e.g. analysing the path name where the content piece was found).
   2.3. Fingerprint Generator Module. This module generates a unique fingerprint of each content element from the information provided by the content aggregator. There exist a number of methods for media fingerprinting; the concrete instance used is not a part of this invention. Fingerprint generation is an optional module intended to improve the matching capabilities of the system; it is however not compulsory and the system could work without it (the only effect being a reduced confidence when matching media items).
   Once the content collection subsystem has extracted the set of all content items available in the user home network, together with their associated metadata (filename, timestamp, associated file data) it sends them to the content identification subsystem at the provider side by opening a network connection to it across the Internet and sending the items as associated to the user's account at the service provider. The optional media fingerprint will be extracted and sent on request by the server, when the identification process demands it.
3. Server-Side Components
   3.1. Content identification. This is a server-side component, located in a centralized location at the service provider side, and connected to the media collection module through an Internet link. It receives the list of located media files together with their associated metadata, and contains the following blocks:
      3.1.1. Matching Module. It compares the generated fingerprints with an external database in order to identify exactly the content.
      3.1.2. Metadata Database. A database that contains a global catalog of elements from the domain being targeted (movies, TV series, music, etc.) with optionally a robust unique identifier for each content element. This database can be started at the provider side with an initial load from a database of available content, and is updated with all identification metadata provided by new elements at each of the subscribers' home networks, gathering thus knowledge across all the user base.
   3.2. Profile Server. This is a server-side component used for providing user profiles to the recommender server.
      3.2.1. Profile Generator. This module creates the user profile by analyzing all the identified items in the user's multimedia content collection. The information about the user preferences becomes especially important in this module's job.
   3.3. Recommendation Server. This is a server-side component used for providing item recommendations and for providing API for third parties. It contains:
      3.3.1. Recommendation Engine. This module provides content recommendation, and uses the recommendation profile generated by the previous module. The specific algorithms used for recommendation are not the aim of this ID.
      3.3.2. Recommendation Distributor. It provides an API for delivering the recommendations to third parties, as well as to the local library management subsystem mentioned in the next item.
4. Local Library Management. This subsystem takes advantage of the results produced by the content collection system and the recommender engine at the server side to provide additional services to users, thereby enhancing the value of the system. At the same time, its output improves and refines the metadata fed to the recommender engine, so there is a positive feedback loop between them. It contains:
   4.1. Local library. The module holding the metadata for the contents in the local network, which have been collected by the Content Collection system
   4.2. Local organizer: a module intended to ease interaction between the user and the local library, helping her to manage the data in the local library.
   4.3. Local recommender: the local interface to the remote recommender engine. In the process it can inject additional information from the local library (recommendation explanations, additional local library items).
   This is all implemented in a way that limits the demand on interaction effort on the user side. Its placement at client side also ensures utmost respect for user privacy: the catalog of the home library content always remains locally in the home network, and the remote server knows only about isolated user preferences.

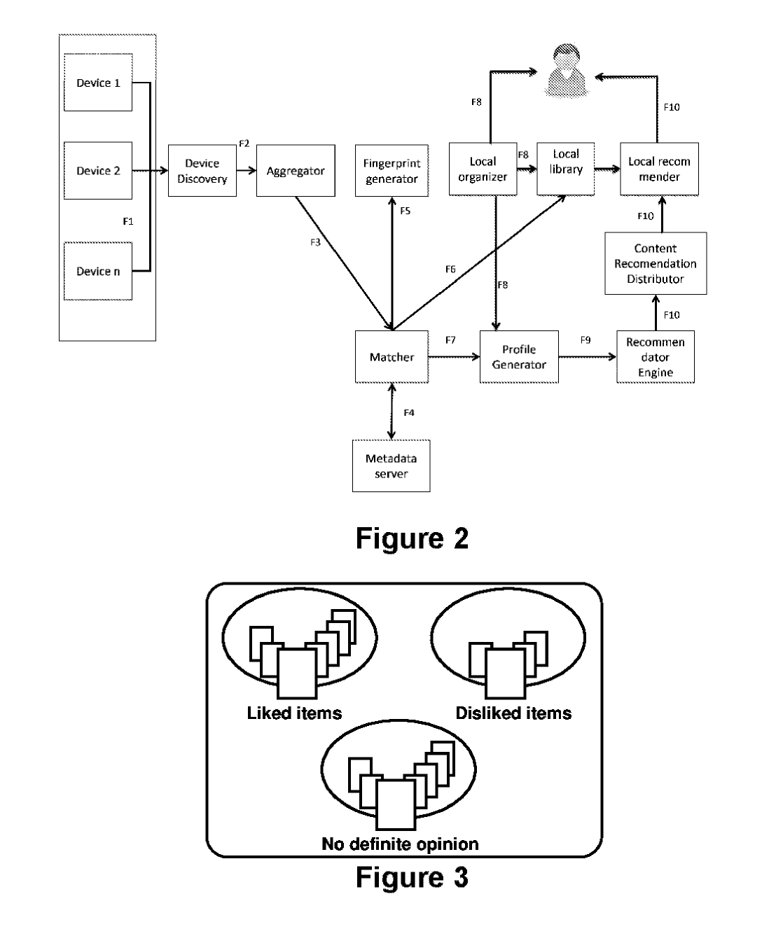

FIG. 2 shows an embodiment of the sequence diagram of the system operation.

The system workflow is shortly explained through the following actions:
F1. The Device Discovery module searches for multimedia content in all the devices connected to the local network.
F2. The Content Aggregator module gathers all relevant content for the domain to be analyzed from all the discovered devices. It puts together all the content into a list after filtering, removing duplicates, etc.
F3. The list of content items and its gathered metadata is sent to the server.
F4. The Matcher Module searches all content items and tries to uniquely identify each piece of media, by making use of its metadata library.
F5. Optionally, the matching module sends the client a request to extract a media fingerprint from ambiguous items. These fingerprints are sent to the server for further identification, producing the final list.
F6. This final list of identified items is sent back to the client where it will be stored in the Local Library
F7. The Profile Generator uses the estimated preferences for items in the Local Library to create or update the user profile.
F8. Optionally, the local management module can fire the Local Organizer and feed it with the information in the Local Library and the estimated preferences. The user is then able to correct, amend or further improve both the local collection and her preferences for it.
F9. The user profile information is sent to the Recommendation Engine, which can then provide content recommendations for all users with an extracted profile. The recommendation techniques used are out of the scope of this ID.
F10. The Recommendation Distributor module provides all these recommendations to third parties, such as portals, video platforms, etc. It also feeds them to the Local Recommender, which can modify the results as explained in the relevant section.

Content Collection:

The first phase, Device Discovery, will locate devices in the local home network suitable for storing media files. A non-exhaustive list is:
Mobile devices, containing media files in a format typically adapted for consumption in a mobile screen and environment
Set Top Boxes equipped with a hard disk and a time shifting/Past TV service
Local PCs and NAS devices, hosting storage space for media files downloaded from a number of Internet media services
Tablets and similar equipment capable of holding media files

The Content Aggregator module will then check each file that can be located through the browsing APIs enabled by the protocols used in device discovery. The procedure is as follows:
a) The file format will be analysed and checked against the list of desired media formats (in our example, video files); this is typically done by analysing the file header (e.g. the first 512 bytes)
b) Files having the desired format will be added to the internal list
c) The following information will be added for each file:
   File name, as stored in the device. The name frequently (but not always) will be the name of the original media production, adapted to the restriction of file system names. This information will be useful for the profile construction.
   A file timestamp, which represents the file modification time (typically corresponding to the time when the file was downloaded/added to the device)
   File location (device & file path within the location). This might give additional hints about the media item (or enable to relate different media items closely located). This information will also be useful for profile construction.
   Media playtime duration, which, for some media formats, is a field within the format, and for others, can be computed by accessing some format internals (e.g. presentation time stamps, or frame counts) and/or performing simple computations (e.g. file size divided by play average bitrate).
   A file hash (e.g. MD5 or SHA1) computed over the file's contents, and intended for direct matching against identical files previously analysed for other users.
   For the devices that allow it, any additional metadata that could be gathered. For instance, time-shifting services in advanced Set Top Boxes record broadcasted TV programs as instructed by the user (or by an automatic triggering service) into a local file, and they may also add recorded program information to a local database. If this database can be queried, basic metadata about the recorded media (broadcasted name, directors/actors/release data for a recorded movie, etc.) can also be captured.

The contents of this aggregation module will be sent over the Internet connection to the Content Identification module at the server side. Note that, to ensure privacy preservation, data about local content items is sent anonymously, i.e. not linked to the user account (though the connection is still authenticated to avoid malicious metadata injection).

Content Identification:

The metadata sent for each content item is used to identify it univocally against a database of items at the server side. The process is as follows:
a) First, the file hash is matched against all the hashes in the database. If a match is found, then the file is identified as the item to which the hash belongs.
b) If a hash match is not found, a fuzzy match is attempted using the filename and the media duration. The filename is matched against item titles in the databases, using string distance with a few provisions (cancel the effect of different encodings, use an optional stop word list and, if needed, a bag-of-words approach). The media duration is matched against item duration in the database, with a certain tolerance to account for local modifications (e.g. file truncation to remove closing credits, or speedup produced by movie-to-pal 2:2 pull-down).
   A final filter is used by using the file timestamp as a threshold: when compared with the item release date, candidates whose release date is older than the file timestamp are discarded (e.g. if the file timestamp is 6 month old, all items released in the last 6 months are removed).
c) In the cases in which the regular content identification did not succeed in finding a unique match for the media item, the simplest procedure is to discard the item. However in certain occasions alternative procedures might be used to increase the matching results (and therefore the system capability to identify user preferences).
   If all candidate matches are close enough in semantic meaning, they could be all added as match results, with possibly a somehow reduced confidence. E.g. we could label all different movie versions simultaneously. As a simple example, consider the case of a found file with the name “Sabrina”, and let us assume that movie duration matches both the original Billy Wilder film of 1954 and the remake directed by Sydney Pollack in 1995. We could assume that, given that both films are actually very close (same script, same genre and thematic content, both directed and acted by famous directors/actors in their time) the user preference would be equally directed towards both, and can therefore add both of them to the list to build the user profile.

Finally, for those cases for which unique identification is not possible, or if increased precision is needed, an additional procedure using media fingerprints might be used. This is detailed in the next paragraphs.

Once a given file has been uniquely identified, it's computed hash is added to the database, so that subsequent requests coming from other users that happen to include exactly the same file can be resolved fast.

As mentioned, video fingerprinting is an optional component that can be included in a variant embodiment of this invention. As such, it provides a much-increased capacity of media identification, given that there exist robust video fingerprint technologies capable of matching video items by analyzing the media at the image and audio level [2, 3]. The computed fingerprints can correctly identify items even if they have suffered intensive transformation (cropping, resizing, transcoding, etc.) and are therefore suitable for higher precision content matching.

They, however, present also drawbacks:
Extraction of media fingerprints can be computationally intensive. This could impose a considerable burden on the media collection device (which in many cases has limited computational power, e.g. a router or a media player).
Typically, they need access to raw media. This increases the bandwidth needs in the home network when performing the content collection phase.
The same requirement (access to raw media) can collide with media downloaded from subscription or pay-per-view services, in which DRM protection precludes access to video and audio samples outside the range of officially sanctioned players.
At the server side, it needs a precomputed database of video fingerprints spanning the whole media collection, which may be infeasible or impractical.

For these reasons, video fingerprint is integrated into the workflow as an optional step, which will be triggered only in the cases in which content identification via the other, less costly, procedures, have not succeeded.

The concrete video fingerprinting integrated into the system is not an integral part of this invention.

Local Library Management:

Although terribly useful for the proper building of a user model in the recommender, explicit item rating is a burdensome task for the user (especially when done in batches). So every effort made to streamline the process and ease the load will pay off by increasing the feedback received.

In the case of this invention, it uses local content discovery as an initial way to augment the user model with no effort on the user side. However we can progress further and take advantage of the system infrastructure to improve the modeling with actual explicit user feedback, while keeping the demand on users' interaction at a very low level. At the same time we encourage user participation by offering the additional advantage of helping on the organization of the local content set (which, for most users, is typically an ad hoc collection of items acquired and stored without cataloguing and structuring, and hence in dire need of systematization).

This dual purpose is therefore exemplified by the double outcome produced:
(a) Management utilities for the local content discovered in the home network, providing functionalities such as duplicate removal, screening of unwanted content, and listings of items grouped by preference.
(b) Improvement of the recommendation effect, through gathering of user feedback on inferred content preferences (to improve the user model at the recommender engine), and addition of explanations for recommended items based on their links to local content.

Once all new content items in the local home network have been discovered and identified, an interface is launched to inform the user about the local collection and enable her to:
Examine the contents on its local library, possibly ordered by the distinct metadata fields fetched after content identification.
Allow exclusion of user devices and/or folders within the devices from the crawling process, as well as boosting the estimated user preference for items in certain places.
Remove identified duplicate items (a not-so-uncommon phenomena in home repositories, which may get cluttered along time with different copies of the same content), thus freeing up disk space.
Label items the system was not able to identify, if the user so desires.
Improve the implicit rating assigned by the user to local content items, by means of a streamlined interface explained below.
Deletion of unwanted items; for this task the system may directly propose a dataset to delete: that of items confirmed as disliked by the user (for single-home users), or the ones that all household users have marked as disliked. In multiple-user configurations, each user interacts with the system at different moment in time. The system records the interactions, and when a full round is finished, it is able to resolve which items in the library did not retain interest from any user.

A variant embodiment of this invention, therefore, provides a module and method for optimized user correction of embedded preferences. The available recommendation engine is used to extract the initial guess about the item preference, so that the user needs only to correct (or confirm) that guess.

Furthermore, we avoid the operational and cognitive burden of traditional-style rating interfaces in which users are requested to mark their preference in a certain scale (typically a 5-point scale), and simplify it with just two clusters (‘like’ and ‘dislike’), plus a third ‘undefined’ group, for items unknown to the user or for which she does not have a clear opinion. Even though the items in the local library are in the user home network, the present invention cannot assume that the user knows about all of them: she may have forgotten about an item acquired long ago, an automatic component (such as a PVR or a time-shifting device) may have downloaded it on her behalf, or it can simply have been inserted in the network by another member of her family. Estimated user preferences are threshold into these three clusters (like, neutral, dislike) and the clusters are shown to the user through a module that enables a very easy transfer of items from one cluster to another. An example embodiment is shown in Error! Reference source not found., which shows the three mentioned clusters. Available user actions on this instantiation are:
Browse cluster contents through the scrollable interface, in this embodiment delivered as a carrousel showing graphical item representations (e.g. cover artwork)
Drag items from one cluster to another, thereby providing an explicit change of the user preference (items dragged can be greyed out or removed from the list, to signal that they have already been confirmed)
Confirm the final clusters, once the user is satisfied with the results.

Content items will be typically asymmetrically distributed across the clusters, with greater amounts going to the “like” cluster (logically, the items in the home network will be mostly content the user likes; otherwise they would not be there). However the “dislike” items, few as they may be, are of high relevance since they express potential outliers (items for which the user has an implicit interest since they are in her local network, but for which the recommender thinks the preference score is low) that could improve significantly the engine performance if confirmed or corrected.

Recommendation Profile Construction:

Once all identifiable media items have been collected and matched, they are sent to the profile construction subsystem. This component uses the content items as samples of the user tastes, and builds an initial user profile from it, which will be then sent to the recommendation engine to help it provide personalized recommendations from the start (thereby alleviating the cold start problem).

The procedure could be repeated periodically, and the user profile conveniently updated, as more content is gathered from the user's home network.

The profile reconstructed from media items can be used for both Content-Based Recommendation Engines as well as for Collaborative Filtering approaches. In both cases it takes the shape of a set of items and a measure of user preference for each of them.

In its most simple formulation, this preference takes a unary format: items in the collection are preferred, all the rest are unknown. However, in general, recommendation engines can work better with a more graded value for preferences, which gives more detail on user tastes (particularly in the case of engines accepting user ratings, which typically take a few values on an integer scale).

Time-Dependent Factors:

For this reason, a variant embodiment of this invention uses an adaptation of the ostensive model for user relevance [1], together with an iterative process, and an a priori expression of similarity between items (for which the same targeted recommendation engine could be used). This variant embodiment uses the file timestamp as a proxy for the varying interest of the user for the item, assuming that older items express less the current interest of the user than newer items (following the principles of the ostensive model). One possible instantiation uses a shifted logistic function.

This example would apply a dampening factor for older items, so that the preference for items older than 12 months (which presumably were watched by the user more than a year ago) reaches a minimum value (but not zero).

The iterative process will be as follows:

A bounded preference scale with a neutral value (neither dislike nor like) at the centre is assumed.

Then, the invention starts with slightly-above-neutral default value as an initial preference value for all found items.

And afterwards, it inputs those user preferences into a cloned version of the recommendation engine and uses the leave-one-out method to refine the prediction of the preference for each found item. That is, for any given item it will add all items to the engine model, save the one being computed, and asks the engine for a preference prediction for the left out item. Then, it repeats this procedure for all items.

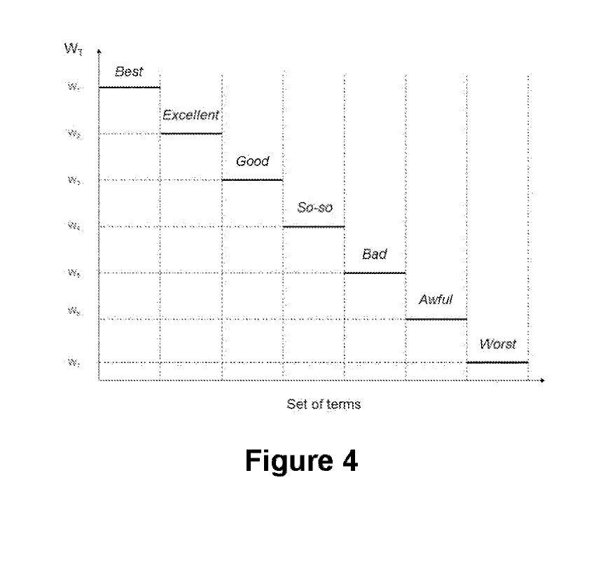

The ostensive equalization is applied to the results, for example as shown in FIG. 4.

And finally, it iterates until the preferences converge.

It is possible to create additional variants for this embodiment that employ different types of equalization, by taking into account more specific adaptations to the domain of recommendations. For instance, it could consider the fact that the valuation of very salient movies (i.e. those at the higher end of the rating scale) tend to fade less with time. In that case, it could substitute the time equalization previously shown by one that takes into account both the time passed and the rating value.

In addition to that time-based preference modification, it can add also a corresponding inverse process for time-dependent score modification for items in the local library, with the aim to obtain a ‘rewatchability’ score: it is assumed that the interest of the user in watching again a content item has a direct relationship with the time elapsed since she watched it. Analogously (but inversely) to the process shown in FIG. 5, this dependency will be different for items with different degrees of preference (items rated high in the preference scale tend to elicit a higher degree of rewatchability). Therefore the use of a corresponding 2D weighting function will yield a score for each item in the local library that can be used as the equivalent to the recommender engine score, and therefore can be used to selectively add (already watched) items in the local library to recommendation lists.

Path Analysis for Preference Refinement:

The analysis of the content file's path name will be used as a new independent factor to predict the user's preferences. The outcome of such analysis will be a positive (like) or negative (dislike) feedback about the content, based on language processing. In case nothing could be inferred, this factor won't be taken into account.

Although the analysis could be as complex as desired, initially it could consist of the detection of significant words that unambiguously lead to a certain type of feedback (e.g. “like”, “good”, “excellent”, “amazing” for positive feedback and “dislike”, “bad”, “awful” for negative feedback). The case of a content file stored into the recycle bin (or the equivalent for each operating system) would be a clear case of negative feedback.

There are several ways of inserting this feature as a factor of the final preference result. We propose here two of them as an example:
A model where both “like” and “dislike” imply that a fixed preference value is assigned to the content item, being the former much larger than the latter. For evident cases (e.g. the recycle bin mentioned above), this could even be the only factor taken into account to estimate the preference value.
A model where “like” and “dislike” mean a weight applied to the preference value previously estimated, again being the former much larger than the latter.
Being:
   P_{E} the final estimated preference
   P the estimated preference so far
   W_{L} the weight to be applied if the user likes the content
   W_{D} the weight to be applied if the user doesn't like the content

$${P}_{E} = PW \{ \begin{matrix}W = {W}_{L} in case of “ like ” \\ W = {W}_{D} in case of “ dislike ”\end{matrix}$$

Another possibility is considering several degrees/levels of feedback as a result of this analysis, assuming that the preference level that each word means is different. The models explained above (or the equivalent ones) are also valid in order to insert this feature into the final preference result. FIG. 6 shows a basic example of preference categorization by term.

Final Delivery:

The results of the recommender engine are sent back to the device implementing the functionality at the user side, in the form of a ranked list of recommended items. Each item has an associated preference score, the one used to rank the list.

The local recommender can improve the results of the remote engine in two ways:
1. It can improve explanations for recommended items by linking them to items in the local library. Explanations are accepted as open important feature of engines, able to increase trust in the system and therefore acceptance of recommendations. CF engines can provide explanations by linking recommended items to similar items known by the user.
   If those explanations coming from the remote server refer to items available in the local library, the local recommender can add a reference to them (e.g. “recommended because is similar to item X, which you own in your local library”). Because of privacy constraints, the contents of the local library are not sent to the remote server. Therefore, the local library is the place to inject those explanations. This increases the sense of proximity for recommendations and therefore can increase users' trust in the results.
2. Or on the other hand, it can improve results by adding items in the local library to the recommendation list, if the combined user preference and time-dependent weight produce a score competitive with the results produced by the remote engine.
It can be noted that the remote engine will never recommend an item contained in the local library, since the user model includes them and therefore the engine assumes that they are not new items, but content known and watched by the user. However if the constraints allow for it, it is advisable for the local recommender to add local items as a proposal to rewatch.

The main advantages of this invention are:

Cold start is a problem for automatic recommendation engines because they do not have initial preference information about the user. This method solves the cold start problem by obtaining a first content list that presumably the user likes.

It creates an initial user multimedia profile without the need for user interaction. Moreover, since the profile is based on implicit feedback (content collected by the user), if the service includes explicit user profiling at user initialization (perhaps by asking the user to rate a few initial items), this invention could easily complement (by providing independent usage information) and reinforce (by enabling a more intelligent selection of the items to be initially rated by the user, based on the implicit profile generated) that explicit feedback.

It tries to complement the impersonal information that comes from the content items themselves with personal tastes or preferences inferred from the elements surrounding the content file (when possible), which will result in a more accurate user profile. Noise is therefore reduced by supplying an objective content set (that of items the user actually took the effort to install in her home) that helps to increase preference recall.

The procedure is repeatable periodically, which would add further refinement to the profile evaluation. It can be successfully combined with more traditional user feedback coming from the server side (such as user ratings or service usage logs).

The section performed on the user home network has been designed to be lightweight on resources (since for most discovered content items only minimal information is gathered, and video fingerprints are computed only over ambiguous items). It is therefore suitable to be hosted in simple devices.

It can improve the quality of explanations for recommended items by relating them to items in the local library.

In addition to standard recommendations for new items, it can also propose to rewatch items in the local library, if the conditions allow for it.

It is usable both in single-user contexts as well as in multi-user homes (where each household member can have his/her own profile).

It provides tools for optimization of the local library (duplicate removal, item identification and management) as well as a very streamlined capacity for explicit user feedback related to the local library

User privacy is respected throughout the whole workflow: the content of the local library remains at the user side, and in no step is information about it sent to the server side (the only data available in the remote user profile is the user's preference values for those items).

It can leverage content discovery across the whole user base (while, as mentioned, still keeping the necessary privacy constraints).

Possibility to use both collaborative filtering and content based recommendation techniques, together with an inferred user profile that could help providing even more accurate recommendations.

Embodiments of the present invention and modifications, obvious to those skilled in the art can be made thereto, without departing from the scope of the present invention.

### ACRONYMS

API Application Program Interface
CF Collaborative Filtering
ID Invention Disclosure
DLNA Digital Living Network Alliance
UPnP Universal Plug and Play
CIFS Common Internet File System

### REFERENCES

[1] I. Campbell and C. J. van Rijsbergen, “The ostensive model of developing information needs,” in Proceedings of COLIS-96, 2nd International Conference on Conceptions of Library Science, Kobenhavn, DK, 1996, pp. 251-268.
[2] Sunil Lee and Yoo, C. D., Robust Video Fingerprinting for Content-Based Video Identification, IEEE Transactions on Circuits and Systems for Video Technology, Volume: 18, Issue: 7, 2008, Page(s): 983-988
[3] Jian Lu, “Video fingerprinting for copy identification: from research to industry applications”, Proceedings of SPIE—Media Forensics and Security XI, Vol. 7254, January 2009
[4] X. Su and T. M. Khoshgoftaar, “A survey of collaborative filtering techniques,” Adv. in Artif. Intell., vol. 2009, pp. 1-19, January 2009.

1.-19. (canceled)

20. A method for creating a user profile for recommendation purposes, comprising:
searching, by a content collection system which is a module located within one device of a local network, for multimedia content items in a plurality of computing devices connected to said local network and owned by a first user; and
gathering, by the content collection system, said multimedia content items found for a specific domain and generating a list with said gathered multimedia content items,
sending, by the content collection system, said generated list together with a set of metadata associated to said multimedia content items to a content identification system which is a server-side component located in a centralized location at a service provider side;
identifying, by the content identification system, each one of said multimedia content items included in said list; and
creating, by a profile generator system of said service provider side, a user profile of said first user by analyzing all of said identified items in said received multimedia content list and further using said created first user profile for providing multimedia content recommendations to said first user and/or to additional users related to said first user through a recommendation engine,
wherein,
the multimedia content items being identified by the content identification system against a database of items at the server-side by means of matching a file hash against all hashes in the database, wherein in case a file hash match is not found in the database a fuzzy match is attempted using a filename and the duration of the multimedia content items, said filename being matched against items titles in the database using a string distance and said duration being matched against the items duration in the database with a certain tolerance; and
the multimedia content recommendations being provided to the first user and/or to additional users related to the first user in the form of a ranked list of recommended items, said ranked list not including items contained in a local library.

21. The method according to claim 20, further comprising adding, by a local recommender, items contained in said local library to the multimedia content recommendations as a proposal for the first user and/or additional users related to the first user to rewatch the multimedia content according to a time-dependent factor.

22. The method according to claim 20, wherein said content is gathered by means of any of a UPnP technique, a Bonjour technique and/or a Samba/CIFs technique.

23. The method according to claim 20, wherein said content collection system further produces a fingerprint for each one of said multimedia content items of said list.

24. The method according to claim 20, wherein the list and description of each one of said identified multimedia content items included in said list are further stored in said local library.

25. The method according to claim 20, wherein said analysis of all of said identified items includes using a timestamp in said identified items as a time-dependent factor to set and/or modify the preference value for said items.

26. The method according to claim 25, wherein said set and/or modified preference value is computed by estimating preference values by means of a recommendation engine, used only for iterative preference estimation, where said recommendation engine uses also said time-dependent factor.

27. The method according to claim 24, wherein said first user corrects, amends and/or improves the description of said stored identified multimedia content items and their preferences for them.

28. The method according to claim 20, comprising performing said steps periodically.

29. The method according to claim 20, comprising further providing by means of a recommendation distributor module said multimedia content recommendations to third parties and further feeding them to a local recommender.

30. The method according to claim 29, wherein said local recommender uses said local library to modify and improve said multimedia content recommendation.

31. The method according to claim 30, wherein said improvement comprising using said local library to inject explanations for items in said multimedia recommendation, personalized for said first user, by linking said items to the items contained in said local library.

32. The method according to claim 25, wherein said improvement comprising using said local library to include additional items in said multimedia content recommendation, by using the items in said local library together with said time-dependent factor.

33. A system for creating a user profile for recommendation purposes, comprising a plurality of computing devices owned by a first user connected to a local network, wherein the system comprises:
a content collection system which is a module located within one device of said local network, said content collection system searching for multimedia content items in said plurality of computing devices, gathering said multimedia content items for a specific domain and generating a list with said gathered multimedia content items and sending said generated list together with a set of metadata associated to said multimedia content items to a content identification system which is a server-side component located in a centralized location at a service provider side; and
server-side components of said service provider side comprising:
said content identification system identifying each one of said multimedia content items included in said list against a database of items at the server-side, by means of matching a file hash against all hashes in the database, wherein in case a file hash match is not found in the database a fuzzy match is attempted using a filename and the duration of the multimedia content items, said filename being matched against items titles in the database using a string distance and said duration being matched against the items duration in the database with a certain tolerance;
a profile generator system for creating a user profile of said first user by analyzing all of said identified items in said multimedia content; and
a recommendation engine using said created first user profile for providing multimedia content recommendation to said first user and/or to additional users related to said first user in the form of a ranked list of recommended items, not including items contained in a local library.

34. The system according to claim 33, wherein said plurality of computing devices comprises any of a PC, a tablet, a mobile phone, a video player or any other device with computing capacity able of storing multimedia content.

35. The system according to claim 34, wherein said content collection system is located within at least one of said plurality of computing devices.

36. The system according to claim 35, wherein said content collection system further comprises a fingerprint generator module to produce a fingerprint for each one of said multimedia content items.

37. The system according to claim 33, wherein a recommendation distributor module is arranged to said recommendation engine to provide said multimedia content recommendations to third parties and further feeding them to a local recommender.

38. The system according to claim 33 configured to implement the method comprising:
searching, by a content collection system which is a module located within one device of a local network, for multimedia content items in a plurality of computing devices connected to said local network and owned by a first user; and
gathering, by the content collection system, said multimedia content items found for a specific domain and generating a list with said gathered multimedia content items, sending, by the content collection system, said generated list together with a set of metadata associated to said multimedia content items to a content identification system which is a server-side component located in a centralized location at a service provider side;
identifying, by the content identification system, each one of said multimedia content items included in said list; and
creating, by a profile generator system of said service provider side, a user profile of said first user by analyzing all of said identified items in said received multimedia content list and further using said created first user profile for providing multimedia content recommendations to said first user and/or to additional users related to said first user through a recommendation engine,
wherein:
the multimedia content items being identified by the content identification system against a database of items at the server-side by means of matching a file hash against all hashes in the database, wherein in case a file hash match is not found in the database a fuzzy match is attempted using a filename and the duration of the multimedia content items, said filename being matched against items titles in the database using a string distance and said duration being matched against the items duration in the database with a certain tolerance; and
the multimedia content recommendations being provided to the first user and/or to additional users related to the first user in the form of a ranked list of recommended items, said ranked list not including items contained in a local library.
